(19) United States
(12) Patent Application Publication
(10) Pub. No.: US 2026/0236644 A1
(43) Pub. Date: Aug. 13, 2026

(54) SELF-SUPERVISED INVERSION METHOD BASED ON TRANSIENT ELECTROMAGNETIC FOR DEEP LEARNING

(71) Applicant: Institute of Geology and Geophysics, Chinese Academy of Sciences, Beijing (CN)

(72) Inventors: Hai LI, Beijing (CN); Ziteng LI, Beijing (CN); Keying LI, Beijing (CN)

(21) Appl. No.: 19/335,380

(22) Filed: Sep. 22, 2025

(30) Foreign Application Priority Data
Feb. 8, 2025 (CN) 202510139486.5

(51) Int. Cl. G06F 30/27; G01V 3/38; G06F 18/10; G06F 18/21; G06F 18/213; G06F 18/214; G06F 111/10; G06N 3/0455; G06N 3/0464; G06N 3/048; G06N 3/0499; G06N 3/084; G06N 3/0895

(52) U.S. Cl. CPC G06F 30/27; G01V 3/38; G06F 18/10; G06F 18/213; G06F 18/214; G06F 18/217; G06N 3/0455; G06N 3/0464; G06N 3/048; G06N 3/0499; G06N 3/084; G06N 3/0895; G06F 2111/10

(57) ABSTRACT

A self-supervised inversion method based on deep learning for the transient electromagnetic data is provided, including: inputting electromagnetic response data into a pre-trained inversion network for inversion to obtain inverted resistivity values; inputting the inverted resistivity values into a pre-trained forward network for forward calculation to obtain forward electromagnetic response data; updating parameters of the inversion network by minimizing the loss between the output forward electromagnetic response data and the input electromagnetic response data to be inverted; re-inverting the electromagnetic response data to be inverted using the inversion network with updated parameters until a preset number of iterations is reached, and finally outputting the inverted resistivity values.

### CROSS-REFERENCE TO RELATED APPLICATIONS

This application claims priority to Chinese Patent Application No. 202510139486.5, filed on Feb. 8, 2025, the contents of which are hereby incorporated by reference.

### TECHNICAL FIELD

The present disclosure relates to the technical field of electromagnetic exploration, and in particular to a self-supervised inversion method based on the transient electromagnetic for deep learning.

### BACKGROUND

Transient electromagnetic method (TEM) is an important electromagnetic exploration technology, and the inversion process of the TEM plays a crucial role in TEM data processing and interpretation. Currently, TEM inversion methods are mainly divided into linear inversion and nonlinear inversion. Linear inversion is highly dependent on initial models and may easily fall into local optimal solutions; while nonlinear inversion usually requires substantial computing resources. With the continuous improvement of computing device performance, deep learning methods have gradually been applied to rapid inversion imaging of electrical methods and achieved significant progress.

Currently, in deep learning-based electrical inversion, data driven-based end-to-end inversion has been widely used in field of electromagnetic inversion due to advantages such as easy network model construction and simple training processes. This data driven-based end-to-end inversion method gives full play to the powerful nonlinear mapping capability of deep learning, directly mapping electromagnetic response data to resistivity models, thereby effectively training the inversion network with high efficiency. Compared with traditional inversion methods, this end-to-end deep learning inversion may achieve rapid inversion through data learning without manually designing the inversion process.

With the proposal of physics-informed neural networks, many geophysicists have begun to try to integrate physical knowledge and prior information into deep learning models as constraint conditions to further reduce reliance on large-scale datasets, while improving network accuracy and generalization capability. The core idea of physics informed neural network (PINN) is to introduce physical laws (such as electromagnetic field equations) as regularization terms, making the network obey physical constraints during training, thereby avoiding overfitting problems that may occur in traditional deep learning methods and maintaining high accuracy even with small datasets.

With continuous maturity of the deep learning technology, self-supervised learning has gradually become an important research direction in field of the deep learning, and potential of the self-supervised learning has been widely applied especially when facing a large amount of unlabeled data. A self-supervised framework for full-waveform inversion constructed based on the autoencoder network drives network updates through the loss function of seismic responses instead of traditional velocity model loss, thereby realizing rapid training of deep learning inversion in the absence of labeled data. This method not only reduces reliance on labeled data but also provides an effective scheme for processing large-scale, unlabeled geophysical data.

The data driven-based end-to-end inversion has certain advantages in computing speed and accuracy compared with traditional inversion, but high reliance of the data driven-based end-to-end inversion on high-quality training sets limits generalization capability of the data driven-based end-to-end inversion. There is often a large deviation between labels generated by numerical simulation and actual geological models, and this deviation directly affects the inversion accuracy of the network. Performance of the network is limited not only by the quality of training data but also by the diversity and representativeness of data. Therefore, the effect of end-to-end inversion may fail to meet expectations in the absence of sufficiently diverse and high-quality datasets.

Physics informed-based deep learning methods significantly increase the time cost of network training because the loss function needs to involve time-consuming forward simulation. Although this method successfully introduces physical constraints into the network model, the method may not effectively transmit the gradient of electromagnetic response loss. This limits the further improvement of model efficiency and performance in training to a certain extent, especially when processing complex geological models and large-scale datasets, which still need to overcome high computational overhead and training difficulties.

In response to this, some scholars have combined data-driven end-to-end inversion with traditional inversion methods, introducing physical information into deep learning networks with the help of physical driving in traditional inversion as a supervision signal to guide network training. This method makes full use of physical constraints in traditional inversion to ensure that the network follows geophysical laws during training. However, this combination relies on traditional inversion methods as the source of physical information, and traditional inversion usually involves a large number of forward calculations, resulting in a slow inversion process. Therefore, although this method may effectively improve the inversion accuracy of the model, its slow computing speed inevitably increases the time cost of deep learning network training, especially when processing large-scale datasets and complex geological models.

In the field of the electrical exploration, the application of self-supervised learning is still limited. The main reason is that the current PyTorch-based seismic full-waveform forward platform is relatively mature and may be effectively combined with the self-supervised inversion framework of deep learning; however, the forward calculation platform in electromagnetic exploration, especially in the TEM, is still blank, making it difficult to effectively apply it to the self-supervised inversion framework of deep learning. Although relevant forward functions have been written through PyTorch and self-supervised geophysical joint inversion has been realized, due to the high complexity of actual forward calculations, there is a large deviation between the calculated response and the actual response, so it has not been widely applied to measured data. In addition, existing self-supervised deep learning inversion methods usually require input of an initial model to better drive network updates, which increases reliance on the initial model to a certain extent.

### SUMMARY

The purpose of the present disclosure is to provide a self-supervised inversion method based on the transient electromagnetic for deep learning to solve the problems existing in the prior art, which is different from traditional end-to-end inversion methods. By directly inputting measured electromagnetic response data, the network model is optimized by minimizing the loss between the measured electromagnetic response and the electromagnetic response corresponding to the resistivity model output by the network, and finally outputting the corresponding resistivity model. This method avoids reliance on numerically simulated training data and has stronger generalization capability when inverting measured data.

To achieve the above purpose, the present disclosure provides following schemes.

A self-supervised inversion method based on the transient electromagnetic for deep learning, including:
inputting electromagnetic response data to be inverted into a pre-trained inversion network for inversion to obtain inverted resistivity values;
inputting the inverted resistivity values into a pre-trained forward network for forward calculation to obtain forward electromagnetic response data;
updating parameters of the inversion network by minimizing the loss between the output forward electromagnetic response data and the input electromagnetic response data to be inverted; and
re-inverting the electromagnetic response data to be inverted using the inversion network with updated parameters until a preset number of iterations is reached, and finally outputting the inverted resistivity values.

Optionally, the inversion network includes an encoder part, a decoder part, and a smooth constraint part;
inputting the electromagnetic response data to be inverted into the pre-trained inversion network for inversion includes:
inputting the electromagnetic response data to be inverted into the encoder part, and extracting features of the input electromagnetic response through three convolutional layers, where the convolutional layer includes a one-dimensional (1D) convolutional layer+a pooling layer+a hyperbolic tangent function (Tanh) activation function;
in the decoder part, restoring and reprocessing the features obtained by the encoder part through three feature upsampling layers, where the feature upsampling layer includes one 1D upsampling layer and two 1D convolutional layers; and
in the smooth constraint part, further smoothing the output of the decoder part by using a convolutional layer with a 1×1 convolution kernel, and finally outputting the inverted resistivity values.

Optionally, inputting the inverted resistivity values into the pre-trained forward network for forward calculation includes:
extracting features from the inverted resistivity values through two convolutional layers to capture local electromagnetic response information; where the convolutional layer includes the 1D convolutional layer+the pooling layer+the Tanh activation function; and
integrating the features extracted by the convolutional layers based on three fully connected layers to extract the forward electromagnetic response data represented by the resistivity values.

Optionally, pre-training the inversion network includes:
generating resistivity values and corresponding electromagnetic response data through numerical simulation, and constructing a dataset based on the resistivity values and corresponding electromagnetic response data;
preprocessing the dataset; and
pre-training the inversion network using the preprocessed dataset; in the pre-training of the inversion network, using electromagnetic responses and resistivity values in the dataset as input and labels of the inversion network, respectively; after the inversion network outputs predicted resistivity, calculating the error between the predicted resistivity and the label through a loss function and driving parameter updates to complete the pre-training of the inversion network.

Optionally, pre-training the forward network includes:
training the forward network based on the preprocessed dataset; in the pre-training of the forward network, using resistivity values and electromagnetic responses in the dataset as input and labels of the forward network, respectively; after the forward network outputs predicted electromagnetic responses, calculating the error between the predicted electromagnetic responses and the labels through a loss function and driving parameter updates to complete the pre-training of the forward network.

Optionally, generating resistivity values and corresponding electromagnetic response data through numerical simulation includes:
setting basic parameters of underground stratum, including top layer thickness and boundary depth of the last layer;
dividing a stratum into a plurality of layers of a same thickness for each layer;
setting a plurality of control points within a preset stratum depth range, where one control point is set at each of the top and bottom of the stratum;
randomly generating a resistivity value for each control point and performing interpolation using a B-spline interpolation method;
generating resistivity-thickness sample data; and
using a central loop device, substituting the generated resistivity-thickness sample data into a 1D numerical simulation method for transient electromagnetics to calculate corresponding electromagnetic response data.
Optionally, inputting the electromagnetic response data to be inverted into the pre-trained inversion network for inversion further includes: performing inversion testing on the electromagnetic response data to be inverted based on a self-supervised inversion method; where the self-supervised inversion method is performed based on the pre-trained inversion network; inputting the electromagnetic response data to be inverted into the pre-trained inversion network, the network outputs initially predicted resistivity values, and then performs secondary update on the pre-trained forward network based on a fast forward training strategy, i.e., solving the real electromagnetic response corresponding to the predicted resistivity values using a forward numerical simulation method, and using the real electromagnetic response and the predicted resistivity values as new training samples to perform secondary training and update on the forward network; recalculating the corresponding electromagnetic response based on the updated forward network, then calculating the error between the electromagnetic response and the input electromagnetic response through a loss function to drive parameter updates of the inversion network; re-inverting the electromagnetic response data to be inverted using the inversion network with updated parameters until a preset number of iterations is reached, and finally outputting the inverted resistivity values.

Advantages of the present disclosure is as following.

By performing secondary training on the forward network, using real forward numerical simulation results to solve electromagnetic responses, and using the resistivity model output by the inversion network as new training samples, it is ensured that the inversion network may gradually update the resistivity model under correct electromagnetic response errors;

By adding a convolutional smoothing layer, resistivity inversion results closer to real situations are achieved (as shown in FIG. 7A and FIG. 7B). By adding a relevant convolutional layer in the last layer of the network model instead of using a fully connected layer, smoother resistivity inversion results closer to real situations are finally achieved.

Compared with the traditional mature Occam inversion method, the present method shows higher accuracy in the inversion of measured data, specifically reflected in that the electromagnetic response of the inverted resistivity model is closer to the measured electromagnetic response.

### BRIEF DESCRIPTION OF THE DRAWINGS

To more clearly illustrate the embodiments of the present disclosure or the technical schemes in the prior art, the drawings required in the embodiments will be briefly introduced below. Apparently, the drawings in the following description are only some embodiments of the present disclosure. For those of ordinary skill in the art, other drawings may be obtained based on these drawings without creative labor.

FIG. 1 is a comparison diagram of the deep learning-based self-supervised inversion method and the end-to-end inversion method according to an embodiment of the present disclosure.

FIG. 2 is a flowchart of a self-supervised inversion method based on the transient electromagnetic method for deep learning in an embodiment of the present disclosure.

FIG. 3 is a training flowchart of the self-supervised inversion network according to an embodiment of the present disclosure.

FIG. 4 is a structural diagram of the fast forward and inversion networks according to an embodiment of the present disclosure.

FIG. 5A, FIG. 5B, FIG. 5C, FIG. 5D, FIG. 5E and FIG. 5F are example diagrams of resistivity models of part of the training dataset according to an embodiment of the present disclosure.

FIG. 6A, FIG. 6B, FIG. 6C, FIG. 6D, FIG. 6E and FIG. 6F are comparison diagrams of test results of different inversion methods on random geoelectric models according to an embodiment of the present disclosure.

FIG. 6A, FIG. 6B and FIG. 6C are comparison diagrams of inverted resistivity model.

FIG. 6D, FIG. 6E and FIG. 6F are corresponding fitting diagrams of the electromagnetic response, respectively.

FIG. 7A, FIG. 7B, FIG. 7C and FIG. 7D are comparison diagrams of inversion results under different forward network training strategies according to an embodiment of the present disclosure.

FIG. 7A is the diagrams of the resistivity results from the self-supervised inversion with secondary training of the forward network; FIG. 7B is an average relative error diagram of electromagnetic response corresponding to FIG. 7A.

FIG. 7C is the diagrams of the resistivity results from the self-supervised inversion without secondary training of the forward network; FIG. 7D is an average relative error diagram of electromagnetic response corresponding to FIG. 7B.

FIG. 8A and FIG. 8B are comparison diagrams of inversion results from different networks structures according to an embodiment of the present disclosure; where FIG. 8A is a resistivity diagram obtained by the inversion using the network structure of the present embodiment, and FIG. 8B is a resistivity diagram obtained by inversion using a traditional convolution+fully connected layer network structure.

FIG. 9A is a comparison diagram of inverted resistivities at measuring point P1 obtained by the Occam inversion method and the self-supervised inversion method.

FIG. 9B is a comparison diagram of the fitting of electromagnetic responses corresponding to the inverted resistivities at measuring point P1 obtained by the Occam inversion method and the self-supervised inversion method with the measured electromagnetic responses.

### DETAILED DESCRIPTION OF THE EMBODIMENTS

The technical schemes in the embodiments of the present disclosure will be clearly and completely described below with reference to the drawings in the embodiments of the present disclosure. Apparently, the described embodiments are only a part of the embodiments of the present disclosure, not all of them. Based on the embodiments of the present disclosure, all other embodiments obtained by those of ordinary skill in the art without creative labor shall fall within the protection scope of the present disclosure.

To make the above objectives, features, and advantages of the present disclosure more obvious and understandable, the present disclosure will be further described in detail below with reference to the drawings and specific implementations.

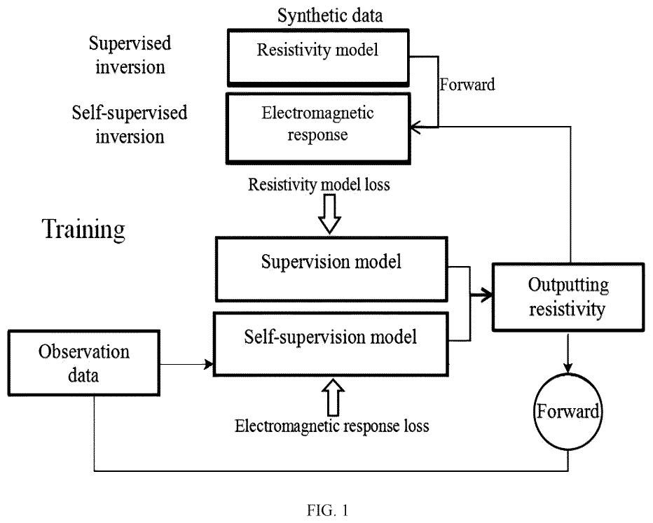

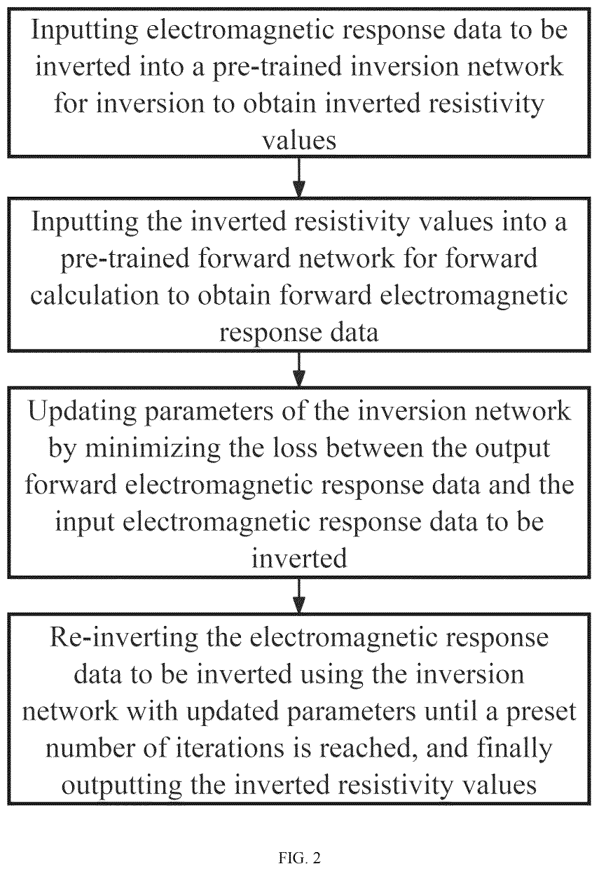

As shown in FIG. 1 and FIG. 2, the embodiment proposes a self-supervised inversion method based on the transient electromagnetic for deep learning, including:
inputting electromagnetic response data to be inverted into a pre-trained inversion network for inversion to obtain inverted resistivity values;
inputting the inverted resistivity values into a pre-trained forward network for forward calculation to obtain forward electromagnetic response data;
updating parameters of the inversion network by minimizing the loss between the output forward electromagnetic response data and the input electromagnetic response data to be inverted; and
re-inverting the electromagnetic response data to be inverted using the inversion network with updated parameters until a preset number of iterations is reached, and finally outputting the inverted resistivity values.

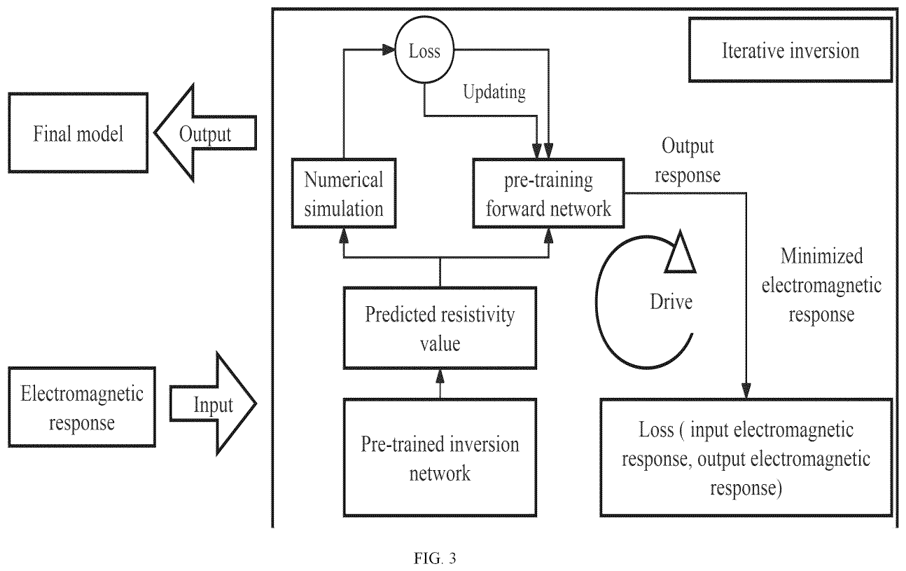

As shown in FIG. 3, the flow of the self-supervised inversion method proposed in the embodiment is as follows: the electromagnetic response data is input into a pre-trained inversion network, and then an underground resistivity model is obtained by inversion (predicted resistivity value); then the forward electromagnetic response of the predicted resistivity value is calculated by the forward part. In the forward part, first, the real electromagnetic response solution is solved by a numerical simulation method, then the real electromagnetic response solution and the predicted resistivity value 1 are used as a new dataset to perform secondary training on the pre-trained forward network, and then the response (output response) of the output resistivity model is calculated through the updated forward network; meanwhile, the error loss between the output response and the electromagnetic response is calculated to update parameters of the pre-trained inversion network. The final inversion result is output by iterating the above process until the preset number of iterations is reached.

In an embodiment, the inversion network includes an encoder part, a decoder part, and a smooth constraint part;
inputting the electromagnetic response data to be inverted into the pre-trained inversion network for inversion includes:
the electromagnetic response data to be inverted is input into the encoder part, and features of the input electromagnetic response are extracted through three convolutional layers, where the convolutional layer includes one-dimensional (1D) convolutional layer+a pooling layer+a hyperbolic tangent function (Tanh) activation function;
in the decoder part, the features obtained by the encoder part are restored and reprocessed through three feature upsampling layers, where the feature upsampling layer includes one 1D upsampling layer and two 1D convolutional layers; and
in the smooth constraint part, further smoothing the output of the decoder part is further smoothed by using a convolutional layer with a 1×1 convolution kernel, and finally the inverted resistivity values are output.

In an embodiment, inputting the inverted resistivity values into the pre-trained forward network for forward calculation includes:
features are extracted from the inverted resistivity values through two convolutional layers to capture local electromagnetic response information; where the convolutional layer includes a 1D convolutional layer+a pooling layer+a Tanh activation function; and
the features extracted from the convolutional layers are integrated based on three fully connected layers to extract the forward electromagnetic response data represented by the resistivity values.

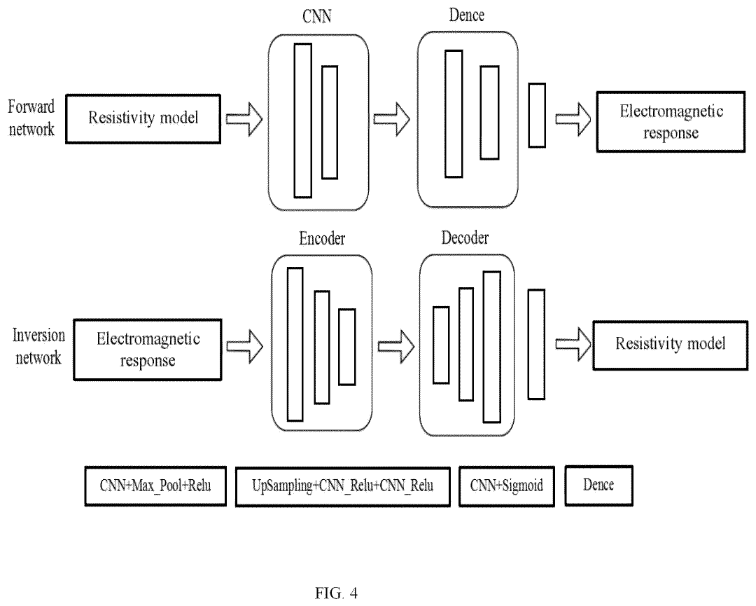

Specifically, in the embodiment, the fast forward network: a 1D transient electromagnetic fast forward network is built through a structure combining convolutional layers and fully connected layers. By combining the local feature extraction capability of convolutional layers and the global information integration capability of fully connected layers, the solving accuracy of electromagnetic responses and the computing efficiency of the network are improved. As shown in the forward network part in FIG. 4, a resistivity model is input, then features are extracted from the resistivity model through two convolutional layers to capture local electromagnetic response information, where the convolutional layers are composed of a 1D convolutional layer+a pooling layer+a Tanh activation function. Finally, the extracted features are integrated based on three fully connected layers to effectively extract and output the electromagnetic response represented in the resistivity model.

Fast inversion network: the fast inversion network is built based on a fully convolutional layer of an autoencoder structure. As shown in the inversion network part in FIG. 4, in the encoder part of the network, an electromagnetic response is input, then features of the input electromagnetic response are extracted through three convolutional layers, where the convolutional layers are composed of the 1D convolutional layer+the pooling layer+the Tanh activation function; the decoder part restores and reprocesses the features obtained by the encoder through three feature upsampling layers to avoid using fully connected layers, where the feature upsampling layers are composed of one 1D upsampling layer and two 1D convolutional layers. In addition, the result is further smoothed by using a convolutional layer with a 1×1 convolution kernel at the end of the decoder network, and finally the resistivity model is output. This design may not only retain the smoothness of the resistivity model but also help to be consistent with the actual geological model, thereby improving the accuracy and stability of inversion results.

In an embodiment, pre-training the inversion network includes:
generating resistivity values and corresponding electromagnetic response data by numerical simulation, and constructing a dataset based on the resistivity values and corresponding electromagnetic response data;
preprocessing the dataset; and
pre-training the inversion network using the preprocessed dataset; in the pre-training of the inversion network, using electromagnetic responses and resistivity values in the dataset as input and labels of the inversion network, respectively; after the inversion network outputs predicted resistivity, calculating the error between the predicted resistivity and the label through a loss function and driving parameter updates to complete the pre-training of the inversion network.

In an embodiment, pre-training the forward network includes:
training the forward network based on the preprocessed dataset; in the pre-training of the forward network, using resistivity values and electromagnetic responses in the dataset as input and labels of the forward network, respectively; after the forward network outputs predicted electromagnetic responses, calculating the error between the predicted electromagnetic responses and the labels through a loss function and driving parameter updates to complete the pre-training of the forward network.

In an embodiment, generating resistivity values and corresponding electromagnetic response data through numerical simulation includes:
setting basic parameters of underground stratum, including top layer thickness and boundary depth of the last layer;
dividing a stratum into a plurality of layers of a same thickness for each layer;
setting a plurality of control points within a preset stratum depth range, where one control point is set at each of the top and bottom of the stratum;
randomly generating a resistivity value for each control point and performing interpolation using a B-spline interpolation method;
generating resistivity-thickness sample data;
using a central loop device, substituting the generated resistivity-thickness sample data into a 1D numerical simulation method for transient electromagnetics to calculate corresponding electromagnetic response data.

In an embodiment, inputting the electromagnetic response data to be inverted into the pre-trained inversion network for inversion further includes:
the electromagnetic response data to be inverted is tested based on a self-supervised inversion method; where the self-supervised inversion method is performed based on the pre-trained inversion network; the electromagnetic response data to be inverted is input into the pre-trained inversion network, the network outputs initially predicted resistivity values, and then the pre-trained forward network performs secondary update based on a fast forward training strategy, namely, a forward numerical simulation method is used to solve the real electromagnetic response corresponding to the predicted resistivity values, and the real electromagnetic response and the predicted resistivity values are used as new training samples to perform secondary training and update on the forward network; the corresponding electromagnetic response is recalculated based on the updated forward network, then an error between the electromagnetic response and the input electromagnetic response is calculated through a loss function to drive parameter updates of the inversion network; the electromagnetic response data to be inverted is re-inverted using the inversion network with updated parameters until a preset number of iterations is reached, and finally the inverted resistivity values is output.

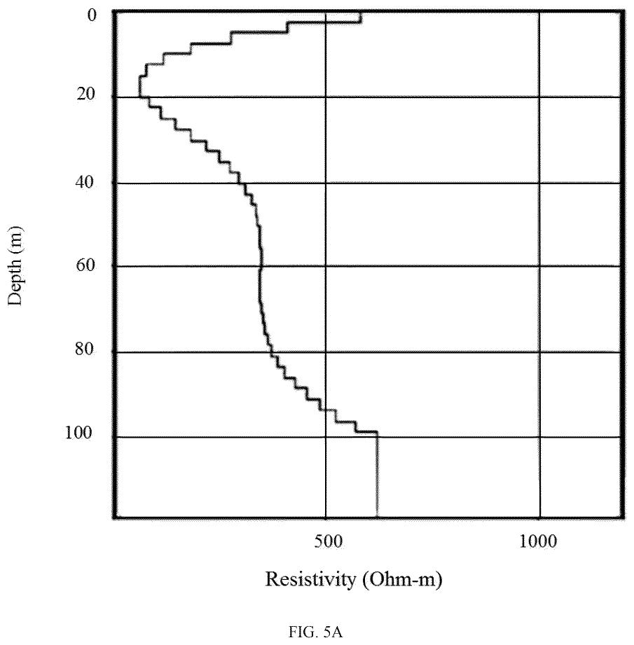

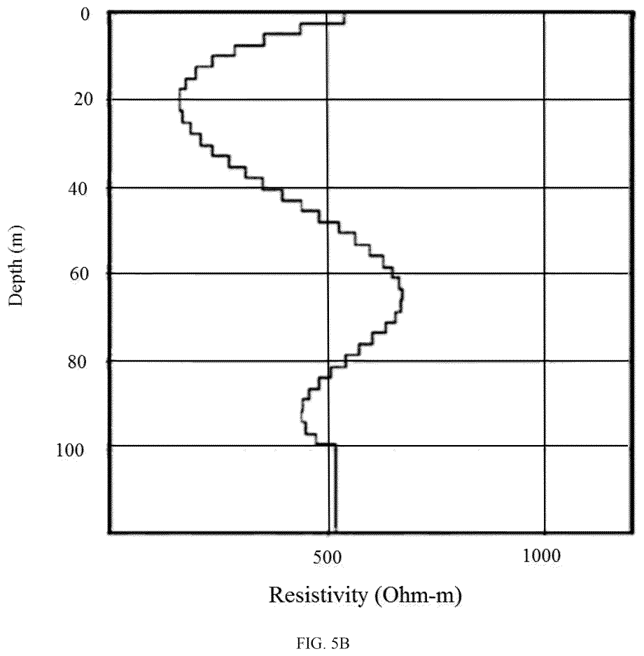

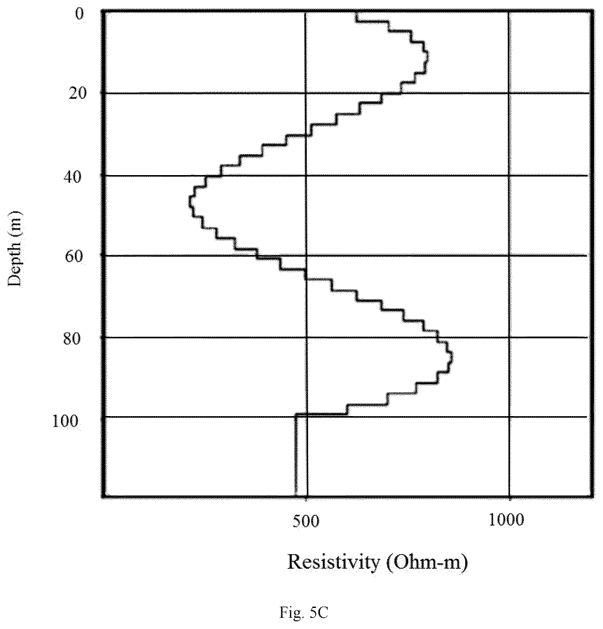

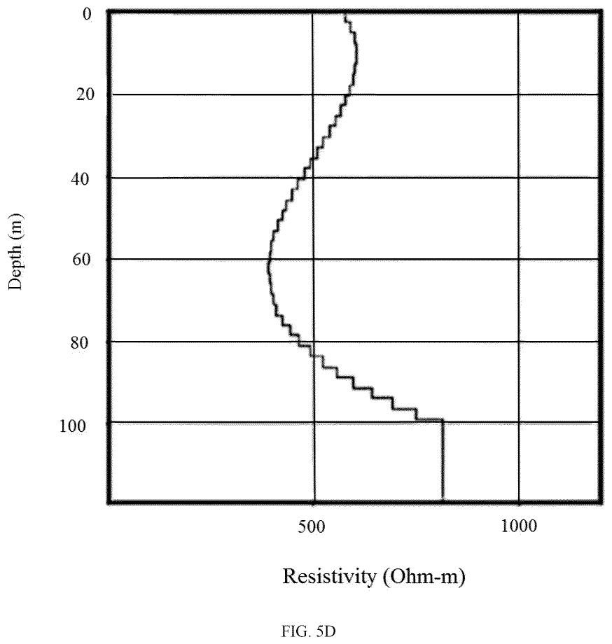

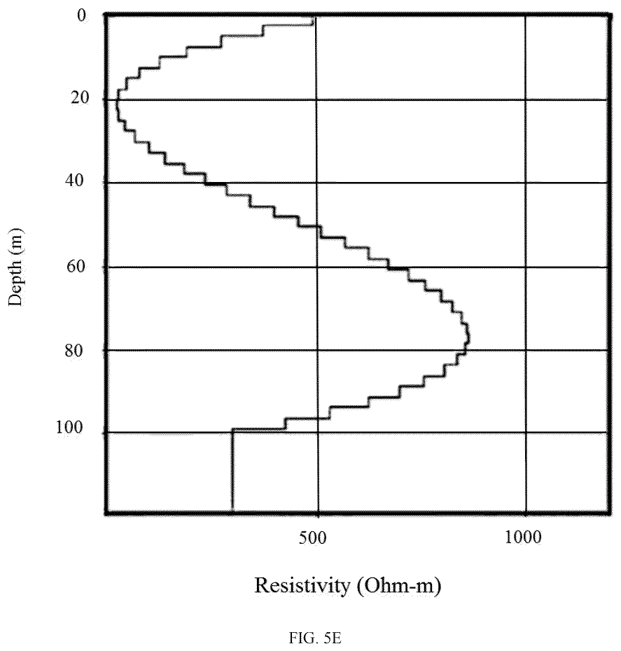

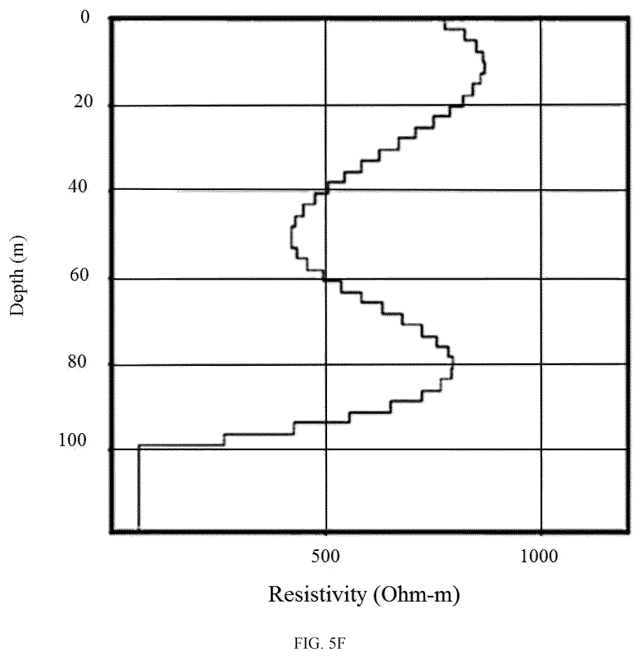

Specifically, in the embodiment, the generation of the dataset used for pre-training the network includes:
the quality of the dataset is very important to the performance of the pre-trained forward and inversion networks. Considering that the resistivity values of actual underground stratum are usually continuously distributed rather than segmented, and the continuous distribution characteristics may well reflect the complexity of underground geological structures. Therefore, to generate a relatively smooth and longitudinally continuous underground resistivity model, the following method is used to generate sample set data in this document: first, the top layer thickness is set to 1 meter (m) and the boundary depth of the last layer to 100 m, according to an equal-thickness method for each layer, the stratum is divided into 40 layers to ensure that the random characteristics of underground resistivity distribution are fully reflected; 5 control points are determined between 1 and 100 m, where the depths of 2 control points are fixed at 0 m and 100 m, and the remaining 3 control points are randomly determined, but the depth between control points is required to be greater than 10 m. The resistivity of the control points is randomly generated within 1-1000 ohm meters (Ω·m), and interpolation is performed using the B-spline interpolation method based on the 5 control points to make the resistivity curve smoother, and finally continuously distributed resistivity values from 1 m to 100 m are obtained. Finally, by using a central loop device, the generated resistivity-thickness sample data is substituted into a 1D numerical simulation method for transient electromagnetics to calculate the corresponding electromagnetic response. A circular coil with a radius of 1.25 m is used, the number of receiving time channels is 61, the sampling time is 1e⁻⁵-1e⁻² seconds(s), and the transmitting current is 1 ampere (A). Finally, 200 training sets are generated for pre-training the forward and inversion networks (part of the data is shown in FIG. 5A, FIG. 5B, FIG. 5C, FIG. 5D, FIG. 5E and FIG. 5F).

To avoid the problem that the network training convergence speed is too slow due to the large scale amplitude of electromagnetic response data, normalization preprocessing is performed on input and output data.

Specifically, in the embodiment, performance test of the self-supervised inversion network is:
in the pre-training process of the forward and inversion networks, the Adam optimizer is used, the learning rate is set to 1e⁻³, the number of training iterations (epochs) is 500, the batch size is 64, and the loss function uses mean absolute error (MAE). After the pre-training of the forward and inversion networks is completed, inversion testing is performed on the measured data based on the self-supervised inversion method. In this process, the self-supervised inversion network is based on the pre-trained inversion network.

In addition, to verify the efficiency of the self-supervised inversion method, a data-driven deep learning inversion network is also trained. Except for the number of training sets, the network model and training parameters of the data-driven inversion network are consistent with those of the self-supervised inversion method. The data-driven inversion network is trained on 20,000 datasets, where the ratio of the training set to the verification set is 9:1.

The above networks are trained based on the TensorFlow 2.1 platform. The computing environment configuration of the experiment is: Intel (R) Core (™) i5-10300H central processing unit (CPU) @2.50 gigahertz (GHz) processor, equipped with 8 Gigabyte (GB) memory.

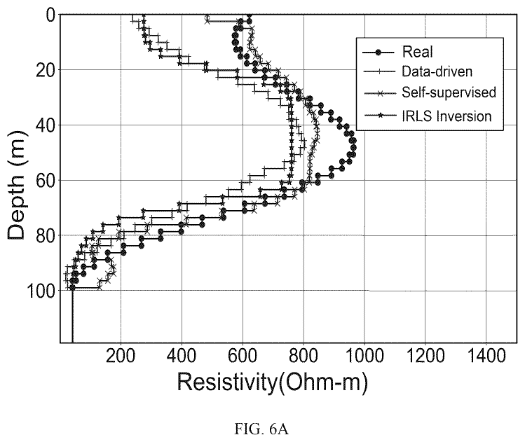

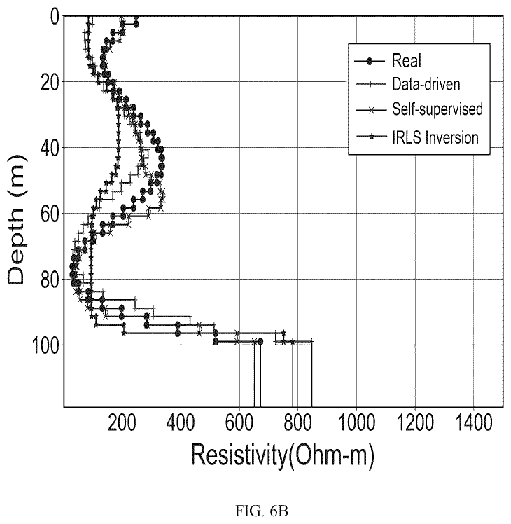

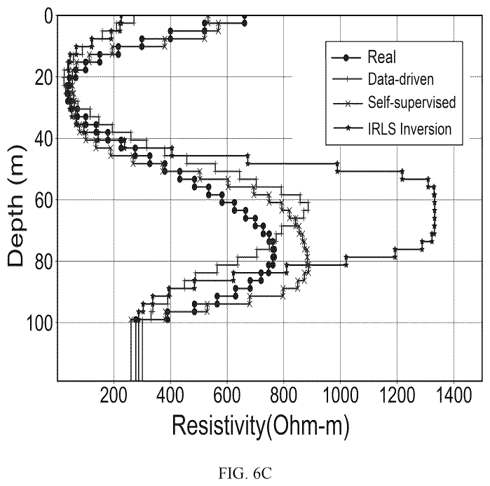

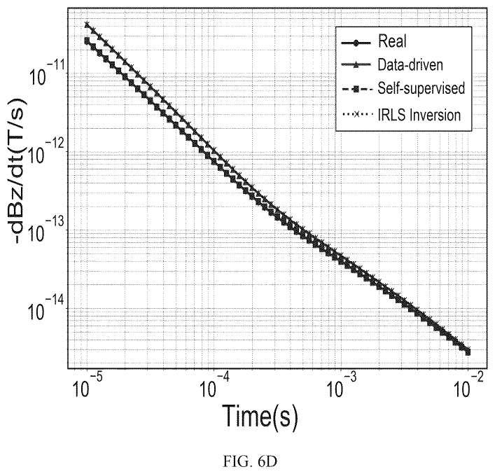

To verify the advantages of the self-supervised inversion method proposed in this application, three geoelectric models are regenerated for testing, and the results are compared with those of the data-driven inversion method and the iterative reweighted least squares (IRLS) inversion method of the traditional linear inversion method (as shown in FIG. 6A, FIG. 6B, FIG. 6C, FIG. 6D, FIG. 6E and FIG. 6F). It may be seen from the results that compared with the inversion results of the data-driven inversion method, the inversion results of the self-supervised inversion method are significantly improved in both the fitting degree of the resistivity model (×line) and the fitting degree of the electromagnetic response data (square). At the same time, compared with the IRLS inversion results, the results obtained by the self-supervised network inversion also show good improvement, further proving the effectiveness and advantages of the self-supervised inversion method in resistivity model inversion. In addition, in the three examples, the computing times of the self-supervised inversion method and the traditional IRLS inversion method are 40 s and 61 s, respectively. It may be seen that the self-supervised inversion method is superior to the traditional IRLS inversion method in inversion speed. Although the computing time of the data-driven inversion method is about 1 s, the time consumed for generating the training set in the data-driven inversion method is huge, about 0.5 hour (h), and this part of time is also required to be considered in the computing time of inversion.

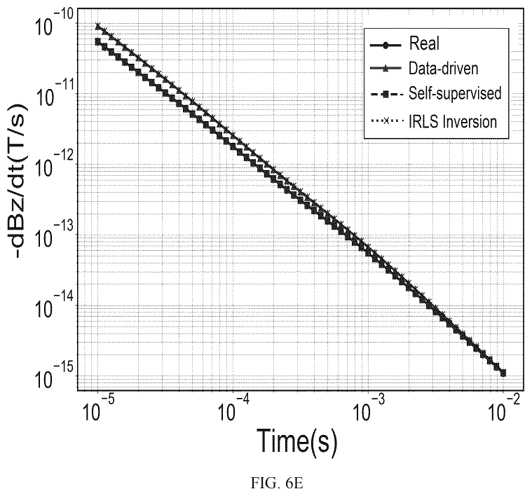

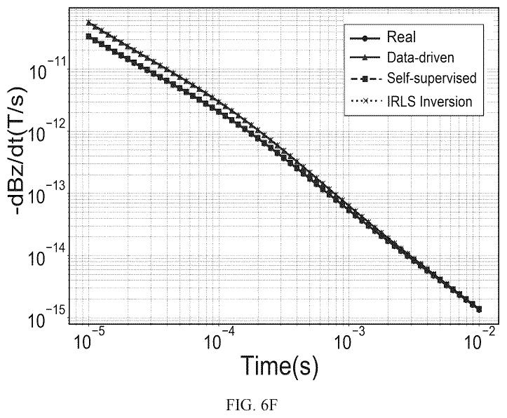

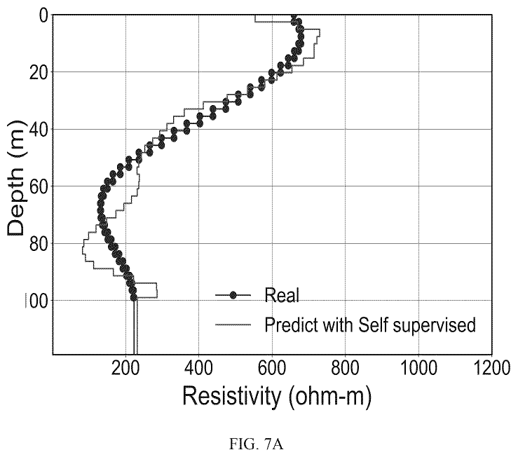

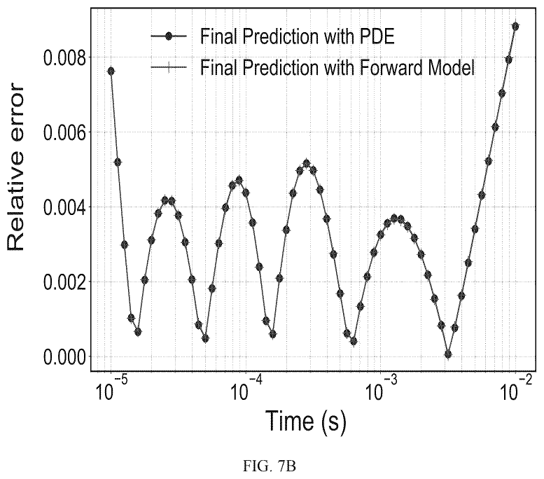

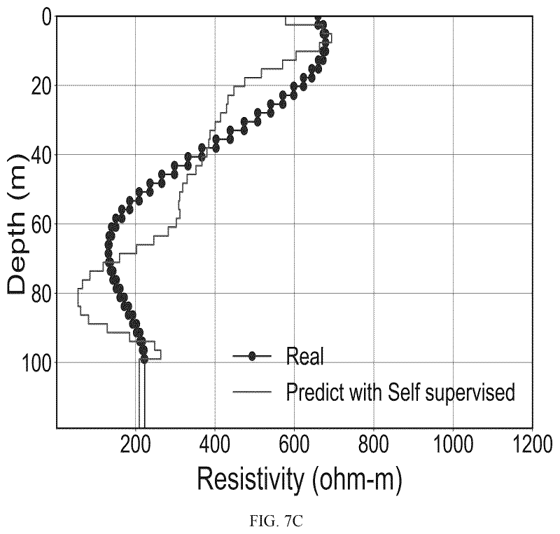

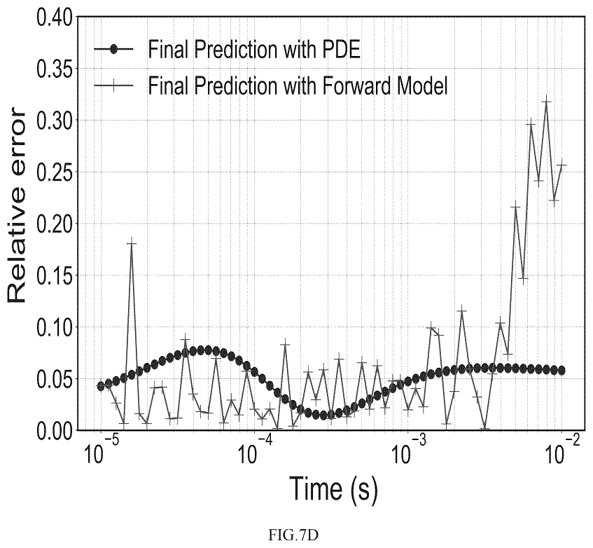

Specifically, in the embodiment, training strategy of the fast forward network is:
as shown in FIG. 7A, FIG. 7B, FIG. 7C and FIG. 7D, self-supervised inversion is performed using the forward network without update and the forward network updated by secondary training, respectively, and the accuracy of the finally output resistivity model is evaluated (the dotted line is the real resistivity model, and the solid line is the resistivity result diagram of self-supervised inversion). Meanwhile, the deviation between the electromagnetic response generated by the forward network and that generated by the numerical simulation method is compared to judge the improvement of the secondary training of the forward network on the inversion results (the dots are the electromagnetic response error curves obtained by numerical simulation of the inversion results, and the plus signs are the electromagnetic response error curves obtained by fast forward calculation). It may be clearly observed that the inversion accuracy is significantly improved by updating the forward network. The updated forward network significantly improves the fitting degree of the resistivity model and effectively reduces the deviation between the generated electromagnetic response and the numerical simulation results. This indicates that the secondary training of the forward network not only improves the inversion accuracy of the resistivity model but also enhances the reliability and consistency of the inversion results.

In addition, during the secondary training of the forward network, additional computing consumption may be introduced due to the need for additional numerical simulation. However, through experimental tests, it is found that in the self-supervised inversion network, the computing times for whether the forward network is secondarily updated are 46 s and 16 s, respectively. Although the time consumption is doubled, the inversion accuracy is significantly improved. Considering the significant improvement of inversion accuracy, this additional computing time consumption is acceptable.

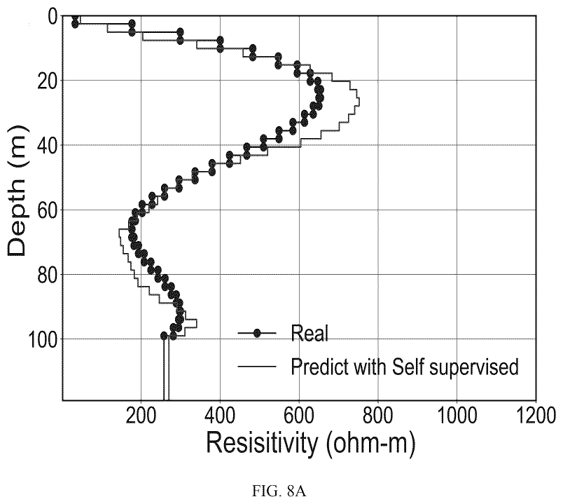

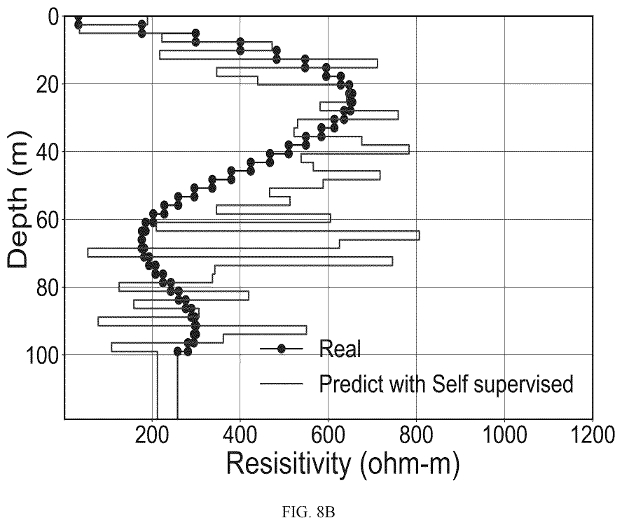

Specifically, in this embodiment, comparison of fast inversion network structures is:
in this part, the results of the inversion network of this application and the traditional inversion network (the decoder part and the convolution output layer of the fully convolutional network in the autoencoder network are all replaced with fully connected layers, and other layers remain unchanged) are compared. The results are shown in FIG. 8A and FIG. 8B. It may be found that the fully connected layer produces obvious jumps between different layers of the inverted resistivity model (dotted line), which is inconsistent with the real model, while the resistivity model (solid line) obtained by the inversion of the network of this application is relatively smooth between adjacent layers. In conclusion, replacing the fully connected layer with the convolutional layer may perform good smooth constraint on the resistivity model and obtain a continuous resistivity model.

Specifically, in the embodiment, measured data is as following:
a transient electromagnetic dataset from the Umatilla Indian Reservation Geothermal Resources Assessment is used to verify the efficiency of the present method. The dataset was collected by the United States Geological Survey in areas of geothermal potential interest, including 23 ground transient electromagnetic data, and transient electromagnetic method (TEM) measurements were performed along 4 profiles using 100×100 m or 40×40 m central loop devices.

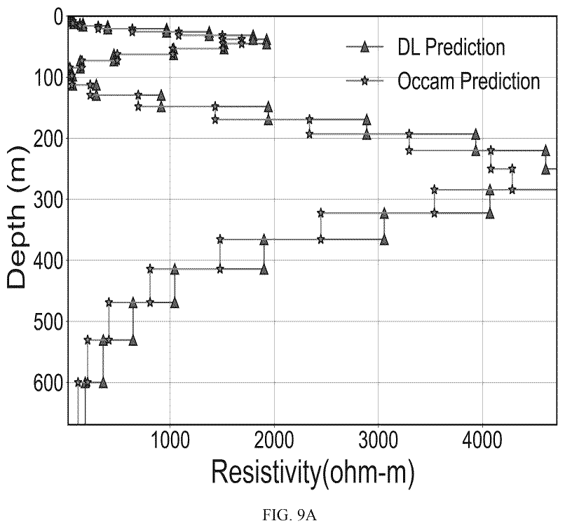

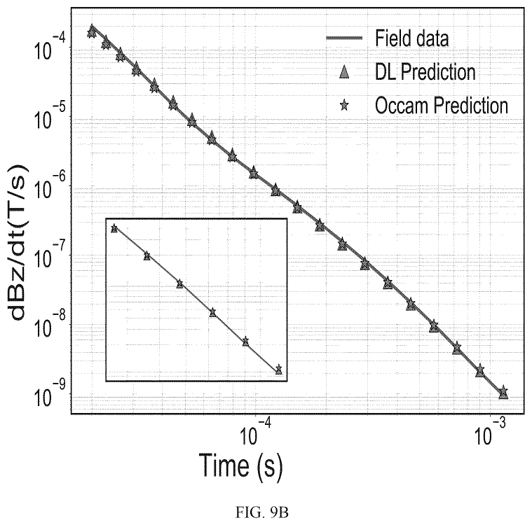

Inversion is performed on the measuring point P1, and the results are compared with those of the traditional Occam inversion method (provided by Jared R. Peacock and Jeffrey D. Pepin) (as shown in FIG. 9A and FIG. 9B). The inversion results show that the resistivity models obtained by the two methods are basically consistent, but in the comparison of electromagnetic response curves, the self-supervised inversion method (triangle) shows higher accuracy and fitting degree.

On the synthetic data, compared with the traditional DL data-driven inversion method and the IRLS inversion method of the traditional linear inversion method, the present embodiment (self-supervised inversion) shows significant improvement in both the fitting degree of the resistivity model and the fitting degree of the electromagnetic response data, as shown in FIG. 6A, FIG. 6B, FIG. 6C, FIG. 6D, FIG. 6E and FIG. 6F. In addition, the present embodiment also has significant advantages in computing time. The time consumed by the present embodiment, the traditional data-driven inversion method, and the IRLS method is 40 s, 1 s (but the time consumed for dataset generation is 0.5 h, which also needs to be considered), and 61 s, respectively.

By performing secondary training on the forward network, using real forward numerical simulation results to solve electromagnetic responses, and using the resistivity model output by the inversion network as new training samples, it is ensured that the inversion network may gradually update the resistivity model under correct electromagnetic response errors (as shown in FIG. 7A, FIG. 7B, FIG. 7C and FIG. 7D).

By adding a convolutional smoothing layer, resistivity inversion results closer to real situations are achieved (as shown in FIG. 8A and FIG. 8B). By adding a relevant convolutional layer in the last layer of the network model instead of using a fully connected layer, smoother resistivity inversion results closer to real situations are finally achieved.

Compared with the traditional mature Occam inversion method, the present embodiment shows higher accuracy in the inversion of measured data, specifically reflected in that the electromagnetic response of the inverted resistivity model is closer to the measured electromagnetic response, as shown in FIG. 9A and FIG. 9B.

As shown in FIG. 1, it is a comparison diagram of the deep learning-based self-supervised inversion method and the end-to-end inversion method. The upper part is the flow of the traditional data-driven deep learning inversion method, and the lower part is the flow of the present method-the self-supervised inversion method.

As shown in FIG. 2, it is a flowchart of a self-supervised inversion method based on the transient electromagnetic method for deep learning in an embodiment of the present disclosure.

As shown in FIG. 3, it is a training flowchart of the self-supervised inversion network. First, inputting electromagnetic response data into a pre-trained inversion network, then performing forward calculation on the resistivity model predicted by the network. Then, updating parameters of the inversion network by minimizing the loss between the output electromagnetic response and the input electromagnetic response, and finally outputting the inverted resistivity model after a certain number of iterations.

As shown in FIG. 4, it is a structural diagram of the fast forward and inversion networks. The upper side is the structural diagram of the fast forward network, which is built based on convolutional layers and fully connected layers. The lower side is the structural diagram of the fast inversion network, which is based on an encoder-decoder structure and adopts a fully convolutional layer structure, especially using 1D convolution in the output layer.

As shown in FIG. 5A, FIG. 5B, FIG. 5C, FIG. 5D, FIG. 5E and FIG. 5F, they are example diagrams of resistivity models of part of the dataset.

As shown in FIG. 6A, FIG. 6B, FIG. 6C, FIG. 6D, FIG. 6E and FIG. 6F, they are comparison diagrams of test results of different inversion methods on random geoelectric models, including data-driven inversion, self-supervised inversion, and IRLS inversion. FIG. 6A, FIG. 6B and FIG. 6C are comparison diagrams of resistivity model inversion; FIG. 6D, FIG. 6E and FIG. 6F are corresponding electromagnetic response fitting diagrams.

As shown in FIG. 7A, FIG. 7B, FIG. 7C and FIG. 7D, they are comparison diagrams of inversion results under different forward network training strategies. FIG. 7A, FIG. 7B and FIG. 7C are self-supervised inversion resistivity result diagrams with or without secondary training of the forward network, respectively; FIG. 7B, FIG. 7C and FIG. 7D are corresponding average relative error diagrams of electromagnetic responses, respectively.

As shown in FIG. 8A and FIG. 8B, they are comparison diagrams of inversion results of inversion networks with different structures. FIG. 8A is a resistivity diagram obtained by inversion using the network structure of this document, and FIG. 8B is a resistivity diagram obtained by inversion using a traditional convolution+fully connected layer network structure.

As shown in FIG. 9A and FIG. 9B, they are a resistivity result diagram and an electromagnetic response fitting comparison diagram corresponding to two inversion results of measured data at measuring point P1.

The embodiment proposes a transient electromagnetic inversion method based on self-supervised deep learning. First, based on a data-driven end-to-end network architecture, this embodiment designs a network model dedicated to 1D forward and inversion of transient electromagnetics. The architecture includes two key components: a forward network and an inversion network. The main task of the forward network is to effectively integrate the transient electromagnetic forward process into the self-supervised inversion framework to ensure that the inversion model may generate accurate electromagnetic responses while realizing effective backpropagation of gradients; the inversion network is responsible for ensuring that the resistivity model in the initial inversion result conforms to a reasonable geological shape, thereby providing accurate calculation results for the forward network and further improving the accuracy and reliability of inversion.

On this basis, the embodiment introduces the concept of transfer learning, and constructs a self-supervised framework based on the inversion network model. Different from the traditional training method based on resistivity model loss, this embodiment proposes to drive network optimization through electromagnetic response loss, so that the network may directly learn the mapping relationship from electromagnetic response to resistivity model. Specifically, the calculation of forward response is realized through the forward network to ensure that the calculation results may effectively support the backpropagation of gradients, thereby maintaining optimization efficiency and accuracy throughout the training process; in addition, to ensure that the electromagnetic response calculated by the forward network has high authenticity, the forward network is further subjected to secondary training, real forward numerical simulation results are used to solve electromagnetic responses, and the resistivity model output by the inversion network is used as new training samples. Through this self-supervised learning process, the network may optimize the resistivity model in continuous iteration and finally obtain an accurate geoelectric model.

In conclusion, the method proposed in this embodiment reduces reliance on labeled data and initial models while ensuring the accuracy and efficiency of the inversion process, providing a new idea for the development of transient electromagnetic inversion technology.

The above-described embodiments are only descriptions of the optional modes of the present disclosure, and are not intended to limit the scope of the present disclosure. Without departing from the design spirit of the present disclosure, various modifications and improvements made by those of ordinary skill in the art to the technical schemes of the present disclosure shall fall within the protection scope defined by the claims of the present disclosure.

What is claimed is:

1. A self-supervised inversion method based on transient electromagnetic for deep learning, comprising:
inputting electromagnetic response data to be inverted into a pre-trained inversion network for inversion to obtain inverted resistivity values; wherein an inversion network comprises an encoder part, a decoder part, and a smooth constraint part; and the pre-trained inversion network comprises:
generating resistivity values and corresponding electromagnetic response data through a numerical simulation method, and constructing a dataset based on the resistivity values and the corresponding electromagnetic response data;
wherein generating the resistivity values and the corresponding electromagnetic response data through the numerical simulation method comprises:
setting basic parameters of underground stratum, comprising thickness of a top layer and boundary depth of a last layer;
dividing a stratum into a plurality of layers of a same thickness for each layer;
setting a plurality of control points within a preset stratum depth range, wherein one control point is set at a top and a bottom of a representative stratum;
randomly generating a resistivity value for each of the control points and performing interpolation using a B-spline interpolation method;
generating resistivity-thickness sample data; and
using a central loop device, and substituting generated resistivity-thickness sample data into a one-dimensional (1D) numerical simulation method for transient electromagnetics to calculate corresponding electromagnetic response data; and
wherein inputting the electromagnetic response data to be inverted into the pre-trained inversion network for the inversion comprises:
inputting the electromagnetic response data to be inverted into the encoder part, and extracting features of the input electromagnetic response through three convolutional layers, wherein each convolutional layer comprises a 1D convolutional layer+a pooling layer+a hyperbolic tangent function (Tanh) activation function;
in the decoder part, restoring and reprocessing features obtained by the encoder part through three feature upsampling layers, wherein the feature upsampling layer comprises one 1D upsampling layer and two 1D convolutional layers; and
in the smooth constraint part, performing a further smoothing constraint to the decoder part by using a convolutional layer with a 1×1 convolution kernel, and finally outputting the inverted resistivity values;
inputting the inverted resistivity values into a pre-trained forward network for forward calculation to obtain forward electromagnetic response data;
updating parameters of the inversion network by minimizing a loss between output forward electromagnetic response data and input electromagnetic response data to be inverted; and
using an inversion network with updated parameters to re-invert the electromagnetic response data to be inverted until a preset number of iterations is reached, and finally outputting inverted resistivity values.

2. The self-supervised inversion method based on the transient electromagnetic for the deep learning according to claim 1, wherein inputting the inverted resistivity values into the pre-trained forward network for the forward calculation comprises:
extracting features from the inverted resistivity values through two convolutional layers to capture local electromagnetic response information; wherein each convolutional layer comprises the 1D convolutional layer+the pooling layer+the Tanh activation function; and
integrating the features extracted by the convolutional layers based on three fully connected layers to extract the forward electromagnetic response data represented by the resistivity values.

3. The self-supervised inversion method based on the transient electromagnetic for the deep learning according to claim 1, wherein pre-training the inversion network also comprises:
preprocessing the dataset;
pre-training the inversion network using a preprocessed dataset;
in a pre-training of the inversion network, using electromagnetic responses and resistivity values in the dataset as an input and a label of the inversion network, respectively; and
after the inversion network outputs predicted resistivity, calculating an error between the predicted resistivity and the label of the inversion network through a loss function and driving parameter updates to complete the pre-training of the inversion network.

4. The self-supervised inversion method based on the transient electromagnetic for the deep learning according to claim 3, wherein the pre-trained forward network comprises:
training the forward network based on a preprocessed dataset;
in a pre-training of the forward network, using the resistivity values and the electromagnetic responses in the dataset as an input and a label of the forward network, respectively; and
after the forward network outputs predicted electromagnetic responses, calculating an error between the predicted electromagnetic responses and the label of the forward network through the loss function and the driving parameter updates to complete the pre-training of the forward network.

5. The self-supervised inversion method based on the transient electromagnetic for the deep learning according to claim 1, wherein inputting the electromagnetic response data to be inverted into the pre-trained inversion network for the inversion also comprises:
performing an inversion test on the electromagnetic response data to be inverted based on the self-supervised inversion method; wherein the self-supervised inversion method is performed based on the pre-trained inversion network;
inputting the electromagnetic response data to be inverted into the pre-trained inversion network, outputting an initially predicted resistivity value, and then performing a secondary update on the pre-trained forward network based on a fast forward training strategy, namely, solving a real electromagnetic response corresponding to a predicted resistivity value using a forward numerical simulation method;
using the real electromagnetic response and the predicted resistivity value as new training samples to perform a secondary training and update on the forward network;
recalculating corresponding electromagnetic response based on an updated forward network, then calculating an error between the electromagnetic response and the input electromagnetic response through a loss function to drive parameter updates of the inversion network; and
using the inversion network with updated parameters to re-invert the electromagnetic response data to be inverted until a preset number of iterations is reached, and finally outputting inverted resistivity values.
